(19) United States
(12) Patent Application Publication
(10) Pub. No.: US 2002/0191781 A1
(43) Pub. Date: Dec. 19, 2002

(54) Space efficient buttons

(76) Inventors: Mona Singh, Cary, NC (US); Jack L. Moffett, Pittsburgh, PA (US); Ivan N. Wakefield, Cary, NC (US)

Correspondence Address: COATS & BENNETT, PLLC, P O BOX 5, RALEIGH, NC, 27602, US

(21) Appl. No.: 10/190,918

(22) Filed: Jul. 8, 2002

Related U.S. Application Data
(62) Division of application No. 09/464,356, filed on Dec. 15, 1999.

(51) Int. Cl. H04M 1/00; H04M 9/00

(52) U.S. Cl. 379/419; 379/433.07

(57) ABSTRACT

A button for efficiently displaying indicia on a hand-held device. A button constructed according to a first embodiment includes a main section and an integral extension having indicia positioned thereon. A second embodiment includes a main body section having at least one end containing indicia. Both embodiments provide for the user to actuate the button while still maintaining visible contact with the indicia. The present invention may also include an active character position within the button in which indicia is cycled through by actuating the button. The value of the indicia displayed in the active character position may then be input by an enter function.

### FIELD OF THE INVENTION

The present invention is directed to space efficient buttons and, more particularly, to space efficient buttons for use on hand-held portable devices having indicia positioned on the buttons.

### BACKGROUND OF THE INVENTION

Many electronic devices are becoming smaller in size allowing them to be more easily carried and handled by a user, and stored when not in use. Devices such as cellular phones, cameras, calculators, communicators, and the like have been reduced in size to now fit within the palm of the user's hand and fit within a pocket or purse when not in use. The decreased size has resulted in a number of difficulties in designing the devices to allow them to be easily used.

One problem is the positioning and arrangement of input buttons on the device. The input buttons are necessary to operate the device, such as entering numbers into a calculator or phone, or spelling words within a communicator or phone for transmitting to another party. The positioning is especially problematic considering most devices contain a number of buttons which must be positioned within a single face of a device, such as the ten number keys on a phone. Alternatively, the buttons must not be sized too small making them difficult to press. If the keys are too small and spaced close together, there is a good probability that the user may inadvertently press more than one key or press the wrong key.

Another drawback is being able to identify which characters and indicia correspond to each of the buttons. One commonly used method for indicating the buttons is to position the labels adjacent to the buttons. This orientation proves confusing when there is an array of buttons positioned in close proximity because it is difficult to determine which labels correspond to which of the buttons. Another method places the labels directly on the buttons which has the advantage of easier recognition of the button function. However, a drawback of this design is that the labels are not visible as the user's finger or stylus approaches the button. This may prove exceptionally difficult trying to input information during low light conditions when the labels are illuminated.

Thus, there remains a need for accurately labeling buttons and efficiently utilizing the limited amount of space.

### SUMMARY OF THE INVENTION

The invention is directed to a button configuration having indicia placed on and identifying the button to be visible when actuating the button. A first embodiment of the button includes a main section and an extension integral with and extending from the main section. Indicia placed on the extension is visible when the main section is concealed, such as when being actuated and covered by a user's finger, stylus, or other like device.

This embodiment may also include one or more additional extensions each integral with and extending from the main section. Each of the additional extensions may further contain indicia. Preferably, the extensions and main section have independent and distinct shapes. Also, the main section may have a larger surface area than the surface area of the extensions.

In a second embodiment, the button includes an outer edge, a center point, and at least one end positioned within the outer edge at a position farthest from the center point. Indicia is visibly position within at least one of the ends adjacent to the outer edge allowing for the indicia to remain visible when the majority of the button is concealed. Both of the embodiments may be used on a variety of devices, such as handheld phones, calculators, communicators, etc.

The invention also includes a button having an active character position for visibly displaying a plurality of indicia one at a time. Actuation of the button results in one of a plurality of indicia being visibly displayed within the active character position. A non-active character position may also be located on the button for displaying other indicia.

A method of inputting information into a device is also included. The user views the indicia displayed in the active character position. The button is pressed to selectively change the indicia located within the active character position. When the indicia to be entered is displayed in the active character position, the user activates an enter function.

### BRIEF DESCRIPTION OF THE DRAWINGS

FIG. 1 is a front view of a hand-held device featuring buttons in accordance with the present invention;

FIG. 2A is a front view of a button constructed according to the present invention;

FIG. 2B is a front view of an alternative button constructed according to the present invention;

FIG. 3A is a front view of an alternative embodiment constructed according to the present invention;

FIG. 3B is a front view of an alternative embodiment constructed according to the present invention;

FIG. 4A is a front view illustrating a first character arrangement of a multi-function button;

FIG. 4B is a front view illustrating a second character arrangement of the multi-function button of FIG. 4A;

FIG. 4C is a front view illustrating a third character arrangement of the multi-function button illustrated in FIGS. 4A and 4B; FIG. 5A is a front view illustrating an alternative embodiment of the multifunction button with a first character arrangement;

FIG. 5B is a front view of the alternative embodiment of the multi-function button with a second character arrangement;

FIG. 5C is a front view of the alternative embodiment of the multi-function button with a third character arrangement; and

FIG. 6 is a front view illustrating a wireless communications device incorporating a plurality of buttons constructed according to the present invention.

### DETAILED DESCRIPTION OF THE PREFERRED EMBODIMENT

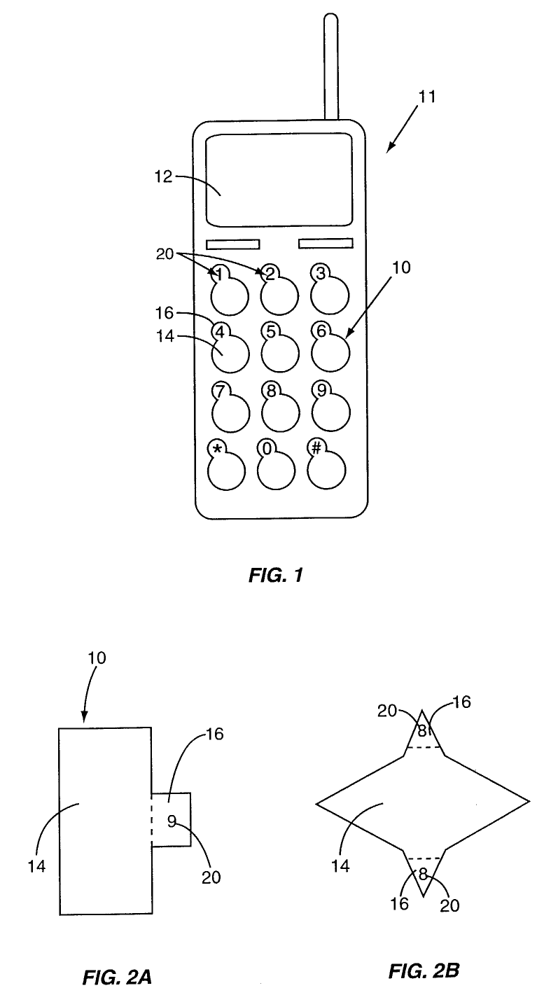

Referring now to the drawings, a button, which is indicated generally by the numeral 10 in FIG. 1, is disclosed for use on portable hand-held devices. The button 10 includes a main section 14 and an integral extension 16. Indicia 20, such as alphanumeric characters, icons, and symbols are visibly positioned on the extension 16. This arrangement provides for a user to visibly maintain sight of the indicia 20 while pressing or otherwise activating the main section 14. The handheld device 11 may further include a display 12 for displaying alphanumeric characters and icons which have been inputted by the user.

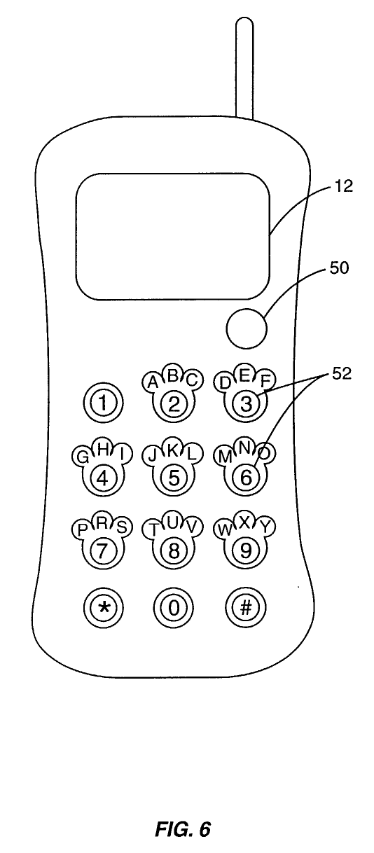

A first embodiment of the button includes a visibly distinct main section 14 and integral extension 16. Although these sections are contained within a single button 10, the extension 16 forms a lobe or other like area independent from the main section 14. FIGS. 2A and 2B include dashed lines to further illustrate the division. The main section 14 provides for a contact point for the user to actuate the button 10. Preferably, the surface area of the main section 14 is greater than the surface area of the extension 16. Additionally, there may be any number of extensions 16 extending outward from and integral with the main section 14. By way of example, the buttons illustrated in FIGS. 1 and 2A illustrate a single extension 20, FIG. 2B and FIGS. 4A-4C illustrate a pair of extensions, and FIG. 6 illustrates buttons having three extensions. The extensions 20 may have a variety of shapes and sizes, and each extension 16 may not be the same size within a single button 10. Preferably, each of the buttons used for inputting alphanumeric characters and icons within a device have the same size and configuration.

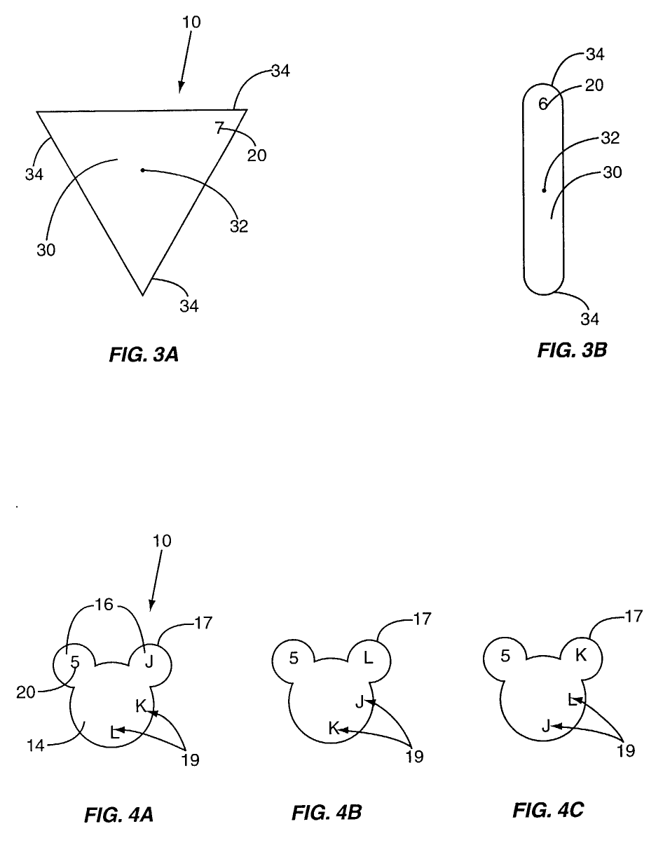

FIGS. 3A and 3B illustrate a button 10 constructed according to a second embodiment. The button includes a single body section 30 having a center point 32. At least one end 34 is positioned on the body section 30 and is defined as the point farthest from the center point 32. This embodiment does not feature an independent extension, but rather positioning the indicia 20 in a remote end area allowing for the user to actuate the button by contacting the main body section 30. By way of example, FIG. 3A illustrates a button 10 having three ends 34, and FIG. 3B illustrates a button having two ends. Adjacent to at least one end is indicia 20 identifying the input value for the button 10. The indicia 20 may be displayed in a variety of formats including FIGS. 3A and 3B having indicia positioned at only one of the ends 34. However, it is to be understood that this embodiment allows for placing indicia at any number of ends 34. In one embodiment, the button 10 has a uniform geometric such as the triangle shape illustrated in FIG. 3A and an oval shape illustrated in FIG. 3B.

The placement of the indicia 20 adjacent to the ends 34 allows for a user to contact the body section 30 without visibly obstructing the indicia 20. Therefore, the user can maintain visual contact with the indicia 20 to confirm that the correct button 10 is being actuated. In one embodiment, the indicia 20 is positioned within the end 34 adjacent to the outer button edge allowing for about 90 percent of the surface area of the body section 30 to remain available for contacting by the user.

The present invention may further include an active character position 17 for displaying a plurality of indicia 20 on a single button 10 one character at a time. After each actuation of the button 10, the indicia 20 appearing in the active character position 17 changes. Non-active character positions 19 may further be positioned within the button 10 for displaying indicia that cycles through the active character position 17.

When the indicia 20 that the user wants to be input is displayed in the active character position 17, the user performs an enter function to input that character. Input functions may include a time delay in which the button is not actuated within a predetermined time period, actuating an enter key, or other like means. The active character position 17 may be used on any shape and style of button 10, and preferably is positioned within an extension 16, or end 34.

FIGS. 4A-4C illustrate an active character position 17 located on the button 10 having two extensions 16. FIG. 4A illustrates the indicia “J” appearing in the active character position 17. The user can input the “J” by actuating the enter function, or may cycle to the next indicia value by actuating the main section 14. If the main section 14 is actuated one time, the character indicia “L” is cycled into the active character position 17 as illustrated in FIG. 4B. When the main section 14 is actuated a second time, the indicia “K” is cycled into the active character position 17 as illustrated in FIG. 4C. The indicia 20 may be cycled through the active character position 17 any number of times by repeatedly actuating the main section 14. The indicia positioned within the active character position 17 may be inputted into the device 11 by pressing a select remote button 50 positioned on the device 11, by a time delay without activating the main section 14 in which a device assumes that the indicia is to be entered, or other like means.

FIGS. 4A-4C further illustrate a second extension 16 including indicia 20 that does not cycle upon activation of the main section 14. Non-active character positions 19 are positioned on the main section 14 displaying the indicia 20 that may be cycled through the active character position 17. This provides for the user to know how many times the button must be actuated to input the desired character. By way of example, the button 10 illustrated in FIG. 4A must be actuated twice for the “K” to be cycled into the active character position 17.

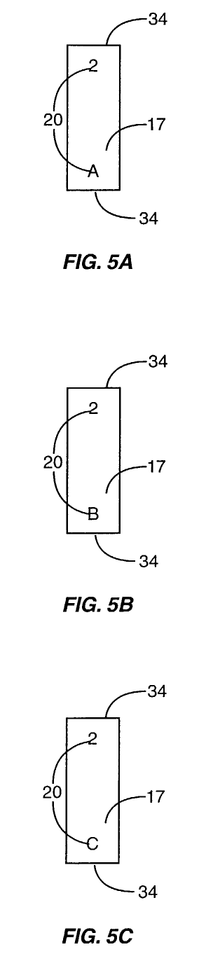

FIGS. 5A-5C illustrate an alternative embodiment of active character position 17 located within one of the ends 34. This embodiment includes a button 10 having two ends 34 in which a first end includes indicia 10 that is static and does not cycle, and the second end includes the active character position 17.

FIG. 6 illustrates another embodiment of the buttons 10 positioned within a cellular phone. Each of the buttons includes a stylus point 52 for receiving a stylus or wand. The phone further includes a mode button 50 for changing between various functions. By way of example, if the mode button 50 is actuated once, the buttons may input the indicia positioned on the main section. Therefore, if button “5” is actuated, a “5” will be entered into the display 12. If the mode button is actuated a second time, the buttons may input the indicia located on the extensions. Therefore, if the “3” button is actuated once, a “d” is placed in the display, twice results in a “e” in the display, and three times an “f” in the display. When the desired character is in the display, the value is input by either waiting for the time period to expire, actuating the mode key 50, or other like enter function. One skilled in the art will understand that there are other methods of inputting and cycling indicia within the display 12, and it is understood that the present invention covers these embodiments. The indicia 20 appearing in the active character position 17 may be displayed in the display 12 before it is input. This assists the user in determining the status of the input information.

Another embodiment allows for the value of each button to be selectively altered by entering the mode key 50 as displayed in FIG. 6. Within this embodiment, the device includes a number of keys each having a plurality of values assigned to the button. By way of example, button “7” has assigned the values “7”, “P”, “R”, and “S”. One of the values of each button is active, with the other values being non-active. When the user actuates the mode key 50, the active value of each button changes. For example, the each button may have the number initially active, and a single actuation of the mode key 50 will change each button value. The second key will have a value of “A”, the third key a value of “D”, the fourth key a value of “G”, etc. When the mode key 50 is actuated again, the each value changes to the next value, such as the second key “B”, third key “E”, fourth key “H”, etc. When the user makes active the desired value, they may actuate an enter function and the corresponding value will be input into the device. In a preferred embodiment, the user presses the button of the desired active value, and the value is displayed on the display 12.

The display of the indicia on each of the buttons may vary depending upon the desired appearance. Examples include displaying only the active value on each button, displaying all the indicia corresponding to the button and highlighting the active value, placing the active value in an active character position and cycling the other values through the non-active positions. One skilled in the art will appreciate there are a number of different manners of displaying the indicia.

The present invention may be carried out in other specific ways than those herein set forth without departing from the spirit and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A push-button for use on a handheld device comprising a main section and an extension integral with and extending from said main section, said extension further including indicia positioned to be visible when said main section is concealed.

2. The push-button of claim 1, further including at least a second extension integral with and extending from said main section, said second extension including indicia positioned to be visible when said main section is concealed.

3. The push-button of claim 1, wherein said main section includes indicia.

4. The push-button of claim 1, further including a stylus point positioned is on the push-button.

5. The push-button of claim 1 wherein said extension and said main section each have independent and distinct shapes.

6. The push-button of claim 1, wherein said main section has a circular shape and said extension has a circular shape.

7. The push-button of claim 1, wherein said main section has a main surface area and said extension has an extension surface area, said main surface area being sized larger than said extension surface area.

8. The push button of claim 2, wherein said main section has a main surface area and said extensions each have an extension surface area, said main surface area being larger than each of said extension surface areas.

9. The push-button of claim 1, wherein a common peripheral edge extends around said main section and said extension.

10. A handheld portable device comprising:
an outer housing;
a display positioned on said outer housing for displaying input characters; and
a plurality of buttons positioned on said outer housing for inputting values into the device, each of said buttons having a main section and an extension connected with and extending from said main section, each of said buttons further including indicia positioned on said extension to be visible when said main surface area is concealed.

11. The device of claim 10, further including indicia positioned on said main section.

12. The device of claim 10, wherein actuation of said main section allows for said indicia to be displayed on said display.

13. The device of claim 10, wherein a majority of said buttons on the device have the same shape and size.

14. The device of claim 10, wherein said main section has a main section surface area and said extension has an extension surface area, said main section surface area being larger than said extension surface area.

15. The device of claim 10, wherein each of said plurality of buttons further includes a second extension integral with and extending from said main section.

16. A button for use on a handheld portable device comprising:
a button having an outer edge, a center point, and at least one end positioned within said outer edge farthest from said center point; and
indicia visibly positioned within at least one of said ends adjacent to said outer edge, wherein concealment of a majority of the button within said outer edge allows for said indicia to remain visible.

17. The button of claim 16, wherein said button has a uniform geometric shape.

18. The button of claim 16, wherein said ends with said indicia comprises less than about 10 percent of the total surface area of the button.

19. The button of claim 16, wherein each of said ends includes indicia.

20. A handheld portable device comprising:
an outer housing for containing components of the handheld portable device;
a display screen positioned within said outer housing for displaying messages; and
a plurality of input buttons spaced about said outer housing, each of said buttons having an outer edge, a center point, and at least one end positioned a distance farthest from said center point, said plurality of input buttons further including indicia visibly positioned within at least one of said ends adjacent to said outer edge, wherein concealment of a majority of the button within said outer edge allows for said indicia to remain visible.

21. The device of claim 20, wherein a majority of said buttons positioned on said outer housing have the same shape and size.

22. A button for inputting information into a device comprising an active character position for visibly displaying a plurality of indicia one at a time, wherein actuation of the button results in one of said plurality of indicia being visibly displayed within said active character position.

23. The button of claim 22, further including at least one non-active character position located on the button, each of said non-active character positions visibly displays one of said indicia.

24. The button of claim 23, wherein the button includes one active character position and three non-active character positions.

25. The button of claim 22, wherein the button includes a main section having a main surface area and an extension connected with and extending from said main section, said active character position being located within said extension allowing for said indicia displayed in said active character position to be visible when said main section is concealed.

26. The button of claim 25, wherein at least one non-active character position is located within said main section.

27. The button of claim 25, further including at least a second extension connected with and extending from said main section, said second extension including indicia positioned to be visible when said main section is concealed.

28. The button of claim 25, further including a stylus point positioned on said main section.

29. The button of claim 22, wherein said push-button is used on a wireless communication device.

30. The button of claim 22, wherein the button has an outer edge, a center point, and at least one end positioned within said outer edge farthest from said center point, said active character position being positioned adjacent to at least one of said ends.

31. The button of claim 30, wherein the button has a uniform geometric shape.

32. The button of claim 30, further including a non-active character position located away from said end.

33. A method of displaying and inputting information through a button of a device comprising the steps of:
assigning a plurality of values to the button with one of the values being active:
providing an active character position on the button and displaying an indicia corresponding to the active value within the active character position;
detecting a button actuation and in response thereto changing the active value of the button and displaying the indicia corresponding to the active value within the active character position; and
detecting actuation of an enter function and in response thereto entering the current active value into the device.

34. The method of claim 33, further including displaying the indicia corresponding to the active value on an extension of the button.

35. The method of claim 33, further including displaying the current value entered into the device on a display.

36. The method of claim 33, wherein the button has an outer edge, a center point, and at least one end positioned a distance within the outer edge farthest from the center point.

37. The method of claim 33, further including providing a non-active character position on the button for displaying indicia assigned to the button that are not active.

38. A method of receiving information input into a wireless communication device comprising the steps of:
providing a plurality of buttons each having a main section and an extension for displaying indicia;
assigning a plurality of values to each of said buttons with one value being active;
providing a mode key for changing the active value of each button;
detecting a mode key actuation and in response thereto changing the active value of each of said buttons; and
detecting an actuation of one of the plurality of buttons and in response thereto entering the corresponding active value.

39. The method of claim 39, further including displaying indicia on the extension of each of the buttons corresponding to the active value.
